(19) United States
(12) Patent Application Publication
(10) Pub. No.: US 2011/0181763 A1
(43) Pub. Date: Jul. 28, 2011

(54) IMAGE PICKUP DEVICE AND SOLID-STATE IMAGE PICKUP ELEMENT OF THE TYPE ILLUMINATED FROM BOTH FACES

(75) Inventors: Masao Hiramoto, Osaka (JP); Teruyuki Takizawa, Osaka (JP); Yoshiaki Sugitani, Nara (JP)

(73) Assignee: PANASONIC CORPORATION, Osaka (JP)

(21) Appl. No.: 13/003,042

(22) PCT Filed: Mar. 2, 2010
(86) PCT No.: PCT/JP2010/001407

§ 371 Date: Jan. 7, 2011

(30) Foreign Application Priority Data
Mar. 5, 2009 (JP) 2009-051707

(51) Int. Cl. H04N 5/335

(52) U.S. Cl. 348/273; 348/294; 348/E05.091

(57) ABSTRACT

In an image capture device according to the present invention, a number of photosensitive cells are arranged between a first surface 30a of a semiconductor layer and its second surface 30b, which is opposed to the first surface, and the device can receive incoming light at not only the first surface 30b but also the second surface 30b as well. The device further includes an optical system 300 with an optical element 9 for splitting the incoming light into first and second light rays. The optical system 300 is designed so as to make the first and second light rays strike the first and second surfaces 30a and 30b, respectively.

### TECHNICAL FIELD

The present invention relates to a technique for realizing color representation using a solid-state image sensor.

### BACKGROUND ART

Recently, the performance and functionality of digital cameras and digital movie cameras that use some solid-state image sensor such as a CCD and a CMOS (which will be sometimes referred to herein as an “image sensor”) have been enhanced to an astonishing degree. In particular, the size of a pixel structure for use in a solid-state image sensor has been further reduced these days thanks to rapid development of semiconductor device processing technologies, thus getting an even greater number of pixels and drivers integrated together in a solid-state image sensor. And the performance of image sensors has been further enhanced as well. Meanwhile, cameras that use a backside illumination type image sensor, which receives incoming light on its reverse side, not on its front side with a wiring layer for the solid-state image sensor, have been developed just recently and their property has attracted a lot of attention these days. An ordinary image sensor receives incoming light on its front side with the wiring layer, and therefore, no small part of the incoming light would be lost due to the presence of a complicated structure on the front side. In the backside illumination type image sensor, on the other hand, nothing in its photodetector section will cut off the incoming light, and therefore, almost no part of the incoming light will be lost by the device structure.

In a color image sensor, on the other hand, a color arrangement consisting mostly of primary colors is used extensively as a color arrangement for pixels. For example, Patent Document No. 1 discloses a Bayer arrangement that uses RGB and an arrangement in which G (green) is replaced with W (white). These arrangements are basically color arrangements consisting mostly of primary colors. However, color representation that depends heavily on primary colors would achieve only low sensitivity. That is a problem.

To overcome such a problem, color representation is also realized using their complementary colors. Typically, such color representation could be done using magenta (Mg), green (G), cyan (Cy) and yellow (Ye). Such an alternative color representation technique is disclosed in Patent Document No. 2 and is now used extensively as a technique that would achieve reasonably high sensitivity and good color reproducibility. Nevertheless, that color representation technique is only usable in a field integration mode, in which signals representing two vertical pixels are added together, and therefore, the vertical resolution will decrease and false colors tend to be produced, too.

Hereinafter, a color arrangement for use to put the color representation technique disclosed in Patent Document No. 2 into practice will be described with reference to the accompanying drawings. FIG. 12 illustrates the arrangement of basic colors for use to carry out that color representation technique. The color arrangement shown in FIG. 12 is basically a matrix consisting of eight pixels, which are arranged in four rows by two columns and to which four different colors are allocated on a pixel-by-pixel basis. Pixel signals are read on a two line basis compliant with the NTSC standard for TV signals. In that case, the combination of pixels to be read in the second field is shifted by one line from that of pixels that have been read in the first field. The pixel signals in two lines are added together only vertically and their sum is processed as a pixel signal representing one line of the first or second field. In this example, the intensities of photoelectrically converted signals representing magenta, green, cyan and yellow rays will be identified by Ms, Gs, Cs and Ys, respectively, and their red and blue components will be identified by Rs and Bs, respectively. In that case, the signals representing the n^{th} line of the first field will be multiple iterative pairs of the signals S_{n,1} and S_{n,2} given by the following Equations (1) and (2):

S_{n,1}=Ms+Cs=Rs+Gs+2Bs (1)

S_{n,2}=Gs+Ys=Rs+2Gs (2)

On the other hand, the signals representing the (n+1)^{th} line of the first field will be multiple iterative pairs of the signals S_{n+1,1} and S_{n+1,2} given by the following Equations (3) and (4):

S_{n+1,1}=Ms+Ys=2Rs+Gs+Bs (3)

S_{n+1,2}=Gs+Cs=2Gs+Bs (4)

In the second field, these signals are also read in quite the same way. That is to say, a luminance signal Y is generated by adding together signals representing two vertically adjacent pixels for both of the n^{th} and (n+1)^{th} lines. Also, a color difference signal BY is generated based on the difference between the signals S_{n,1} and S_{n,2} of the n^{th} line and a color difference signal RY is generated based on the difference between the signals S_{n+1,1} and S_{n+1,2} of the (n+1)^{th} line. Consequently, the read signals are represented by the following Equations (5) to (7):

YL=(Rs+Gs+2Bs)+(Rs+2Gs)=2Rs+3Gs+2Bs (5)

BY=(Rs+Gs+2Bs)−(Rs+2Gs)=2Bs−Gs (6)

RY=(2Rs+Gs+Bs)−(2Gs+Bs)=2Rs−Gs (7)

As can be seen, according to the color arrangement disclosed in Patent Document No. 2, good color signals can be certainly obtained but the performance will somewhat decline as described above because the signals representing two vertically adjacent pixels are added together.

As opposed to the color representation technique disclosed in Patent Document No. 2, a technique for avoiding adding such signals representing two vertically adjacent pixels by using two color filters for two pairs of similar colors in a single pixel is disclosed in Patent Document No. 3. The basic color arrangement disclosed in Patent Document No. 3 is shown in FIG. 13. The color signal itself is the same as what is disclosed in Patent Document No. 2. According to this technique, signals representing two vertically adjacent pixels are not added together, and therefore, the problems of vertical resolution and false colors can be relieved and good color properties are realized, too. Nevertheless, as color filters representing two colors are provided for each pixel, low arrangement accuracy of those color filters would cause significant deterioration in color properties. That is a problem.

Those color representation techniques were developed so as to be compatible with the interlaced scanning for TV signals. However, progressive scanning is also available as a scanning method that requires no discrete scan unlike the interlaced scanning. If the color arrangement disclosed in Patent Document No. 2 or 3 is adopted in combination with the progressive scanning, the basic color arrangement will have to be as shown in FIG. 14 or 15 even on the supposition that an image memory is used. In that case, with the color arrangement shown in FIG. 14 adopted, a luminance signal and color difference signals will be calculated between horizontally adjacent pixels and between vertically adjacent pixels. On the other hand, if the color arrangement shown in FIG. 15 is adopted, a luminance signal and color difference signals are obtained by making additions and subtractions only horizontally. That is why the better color representation performance will be achieved in the latter case in terms of vertical resolution and false colors.

### CITATION LIST

### Patent Literature

Patent Document No. 1: Japanese Patent Application Laid-Open Publication No. 2008-172580
Patent Document No. 2: Japanese Patent Gazette for Opposition No. 6-28450
Patent Document No. 3: Japanese Patent Application Laid-Open Publication No.1-170289

### SUMMARY OF INVENTION

### Technical Problem

A color representation technique that uses mostly primary colors would achieve only low sensitivity. According to a color representation technique that uses complementary colors, on the other hand, the sensitivity can be increased to a certain degree but the decrease in resolution is a problem. To minimize such a decrease in resolution, it is preferred that two color filters representing two colors be provided for each pixel. However, if those two color filters were arranged inaccurately for each pixel, the color representation performance would decline eventually. That should be a problem, too.

It is therefore an object of the present invention to provide a color representation technique that will achieve high sensitivity almost without being affected by how accurately the color filter are arranged.

### Solution to Problem

An image capture device according to the present invention includes: a solid-state image sensor; and an optical system, which is arranged to make incoming light enter the solid-state image sensor. The solid-state image sensor includes: a semiconductor layer, which has a first surface and a second surface that is opposed to the first surface; and a number of photosensitive cells, which are arranged two-dimensionally in between the first and second surfaces of the semiconductor layer thereof. The optical system includes an optical element for splitting the incoming light into first and second light rays, and makes the first and second light rays respectively strike the first and second surfaces of the semiconductor layer. The photosensitive cells are grouped into multiple unit blocks, each including a plurality of photosensitive cells. At least one of the photosensitive cells included in each unit block receives not only a part of the first light ray but also a part of the second light ray that falls within a different wavelength range from that part of the first light ray simultaneously. In each unit block, at least two photosensitive cells receive light rays falling within mutually different wavelength ranges.

In this particular preferred embodiment, the optical element is a half mirror that transmits a half of the incoming light as the first light ray and that reflects the other half of the incoming light as the second light ray. The solid-state image sensor includes a first filter array that is made up of a number of color separation filters, each of which is arranged on same side as the first surface to face an associated one of the photosensitive cells, and a second filter array that is made up of a number of color separation filters, each of which is arranged on the same side as the second surface to face an associated one of the photosensitive cells.

In a specific preferred embodiment, each unit block includes first, second, third and fourth photosensitive cells. The first and second filter arrays are arranged to make magenta and cyan rays of the incoming light incident on the first photosensitive cell, green and yellow rays of the incoming light incident on the second photosensitive cell, green and cyan rays of the incoming light incident on the third photosensitive cell, and magenta and yellow rays of the incoming light incident on the fourth photosensitive cell, respectively.

In another preferred embodiment, the optical element is a dichroic mirror for splitting the incoming light into a first light ray that represents a primary color and a second light ray that represents its complementary color. The solid-state image sensor includes a filter array that is made up of multiple color separation filters, each of which is arranged on the same side as the first surface so as to face an associated one of the photosensitive cells.

In this particular preferred embodiment, the dichroic mirror is arranged so as to split the incoming light into magenta and green rays. Each unit block includes first, second, third and fourth photosensitive cells. The filter array is arranged to make magenta and green rays of the incoming light incident on the first and second photosensitive cells, red and green rays of the incoming light incident on the third photosensitive cell, and blue and green rays of the incoming light incident on the fourth photosensitive cell, respectively.

In still another preferred embodiment, the image capture device further includes a signal processing section, which processes a photoelectrically converted signal supplied from each of the photosensitive cells included in each unit block and outputs a signal that carries color information about the light that has entered each said unit block.

A solid-state image sensor according to the present invention includes: a semiconductor layer, which has a first surface and a second surface that is opposed to the first surface; and a number of photosensitive cells, which are arranged two-dimensionally in between the first and second surfaces of the semiconductor layer thereof. The photosensitive cells are grouped into multiple unit blocks, each including a plurality of photosensitive cells. At least one of the photosensitive cells included in each unit block receives not only a first light ray that has come through the first surface but also a second light ray that has come through the second surface and that falls within a different wavelength range from that part of the first light ray simultaneously. In each unit block, at least two photosensitive cells receive light rays falling within mutually different wavelength ranges.

### Advantageous Effects of Invention

An image capture device according to the present invention uses a solid-state image sensor in which a number of photosensitive cells are arranged between the first and second surfaces of a semiconductor layer and which can receive incoming light not only at the first surface but also at the second surface that is opposite to the first surface. That is to say, this image capture device can receive light at both sides thereof. If the respective color elements are arranged so that a single color is allocated to each pixel on each side, there is no need to use two split color filters representing two different colors for one pixel, thus overcoming the problem of arrangement accuracy of color filters. Furthermore, if the combinations of colors as disclosed in Patent Document No. 2 are adopted, color representation performance can be enhanced in terms of sensitivity and color reproducibility.

### BRIEF DESCRIPTION OF DRAWINGS

FIG. 1 is a block diagram illustrating a basic arrangement for an image capture device according to the present invention.

FIG. 2 is a cross-sectional view schematically illustrating an exemplary structure for a solid-state image sensor according to the present invention.

FIG. 3 is a top view illustrating an exemplary arrangement of photosensitive cells according to the present invention.

FIG. 4 is a block diagram illustrating an overall configuration for an image capture device as a first specific preferred embodiment of the present invention.

FIG. 5 schematically illustrates the arrangement of an image capturing system according to the first preferred embodiment of the present invention.

FIG. 6 illustrates a basic color arrangement for color filters according to the first preferred embodiment of the present invention.

FIG. 7 is a plan view of an image sensor according to the first preferred embodiment of the present invention as viewed from over its principal surface.

FIG. 8 is a cross-sectional view of the image sensor of the first preferred embodiment of the present invention as viewed on the plane A-A′.

FIG. 9 is a cross-sectional view of the image sensor of the first preferred embodiment of the present invention as viewed on the plane B-B′.

FIG. 10 illustrates the basic color arrangement of color filters according to a second preferred embodiment of the present invention.

FIG. 11 shows the color arrangement of the light rays received by respective photosensitive cells in the image sensor according to the second preferred embodiment of the present invention.

FIG. 12 illustrates the arrangement of basic colors for use to carry out a field integration mode color representation technique that uses magenta, green, cyan, and yellow color filters with one color filter allocated to each pixel.

FIG. 13 illustrates the arrangement of basic colors for use to carry out another color representation technique that uses magenta, green, cyan, and yellow color filters with two color filters allocated to each pixel.

FIG. 14 illustrates the arrangement of basic colors for use to carry out a progressive scanning technique that uses magenta, green, cyan, and yellow color filters with one color filter allocated to each pixel.

FIG. 15 illustrates the arrangement of basic colors for use to carry out another progressive scanning technique that uses magenta, green, cyan, and yellow color filters with two color filters allocated to each pixel.

### DESCRIPTION OF EMBODIMENTS

First of all, the fundamental principle of the present invention will be described before preferred embodiments of the present invention are described.

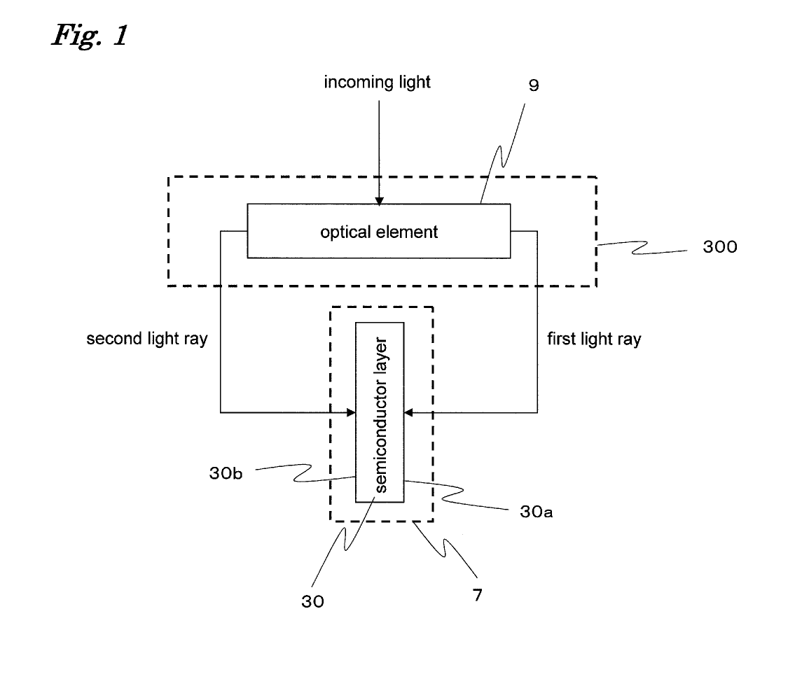

FIG. 1 is a block diagram illustrating a basic arrangement for an image capture device according to the present invention. The image capture device of the present invention includes an optical system 300 for imaging a given subject and a dual-side illumination solid-state image sensor 7. Specifically, the solid-state image sensor 7 has a semiconductor layer 30 and can receive incoming light both at a first surface 30a of the semiconductor layer 30 and at its second surface 30b opposite to the first surface 30a. Between the first and second surfaces 30a and 30b, arranged is a two-dimensional array of photosensitive cells, which will be sometimes referred to herein as “pixels”. Each of those photosensitive cells receives the incoming light at both of the first and second surfaces 30a and 30b. The optical system 300 includes an optical element 9, which splits the incoming light into first and second light rays, and is designed to make the first and second light rays respectively strike the first and second surfaces 30a and 30b of the semiconductor layer 30.

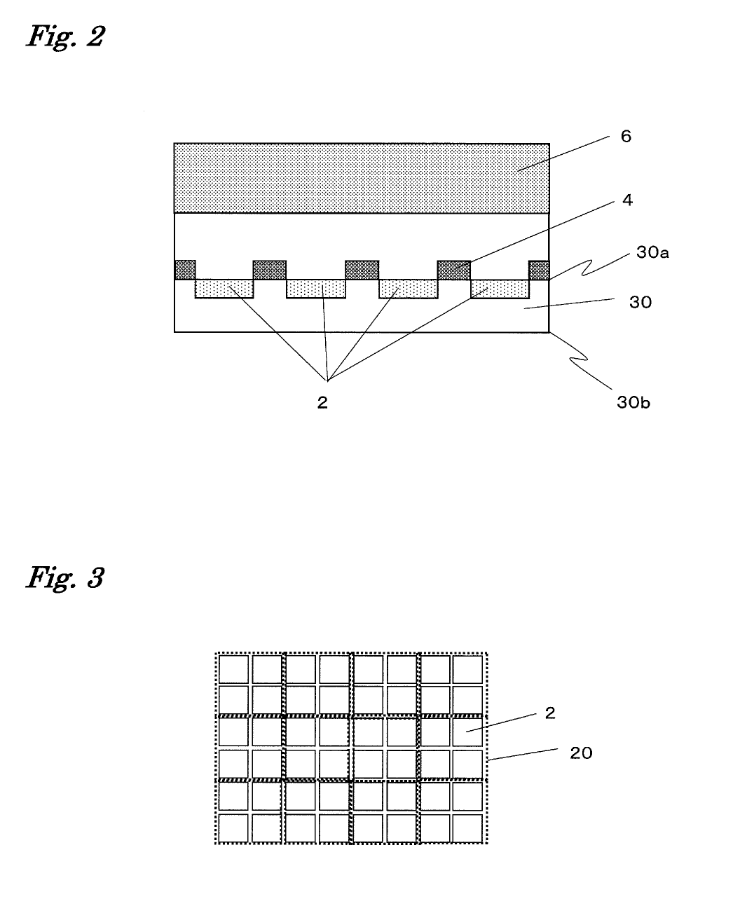

FIG. 2 is a cross-sectional view schematically illustrating an exemplary internal structure for the solid-state image sensor 7. In this example, an interconnect layer 4 is arranged on the same side as the first surface 30a of the semiconductor layer 30. Also, when viewed from the photosensitive cells 2, a transparent substrate 6 to support the semiconductor layer 30 is arranged on the same side as the first surface. With such an arrangement, each of those photosensitive cells 2 can receive not only the light that has been transmitted through the transparent substrate 6 and then incident on the semiconductor layer 30 through the first surface 30a but also the light that has been incident on the semiconductor layer 30 through the second surface.

The optical element 9 shown in FIG. 1 may be a half mirror or a dichroic mirror, for example. Any of those optical elements 9 is designed to transmit a part of the incoming light (i.e., a first light ray) and reflect the rest of it (i.e., a second light ray). The first and second split light rays that have been produced in this manner by the optical element 9 have their optical paths adjusted by a reflective mirror (not shown), for example, so as to strike respectively the first and second surfaces 30a and 30b of the semiconductor layer 30. In this description, a mirror that reflects most of the incoming light will be referred to herein as a “reflective mirror” in order to avoid confusing such a mirror with a half mirror or a dichroic mirror.

Each of the photosensitive cells that are arranged inside of the solid-state image sensor 7 receives the incoming light that has come through both of the first and second surfaces 30a and 30b and outputs a photoelectrically converted signal (or a pixel signal) representing the quantity of the light received. According to the present invention, each element is arranged so that the image produced by the first light ray on the plane on which the photosensitive cells are arranged and the image produced by the second light ray there exactly match to each other.

FIG. 3 is a top view illustrating an exemplary arrangement for an array of photosensitive cells according to the present invention. In this example, the array of photosensitive cells is made up of a number of unit blocks 20, each consisting of multiple photosensitive cells 2. In the arrangement illustrated in FIG. 3, each unit block 20 consists of four photosensitive cells 2. However, this is just an example and each unit block 20 may consist of any other number of photosensitive cells 2. Also, the array of photosensitive cells does not have to have such a tetragonal lattice arrangement, either, but may also have any other arrangement.

In a preferred embodiment of the present invention, the solid-state image sensor 7 and the optical system 300 are arranged so that at least one of the photosensitive cells in each unit block receives light rays falling within mutually different wavelength ranges through the first and second surfaces, respectively. On top of that, the solid-state image sensor 7 and the optical system 300 are arranged so that the light rays received by at least two photosensitive cells in each unit block fall within mutually different wavelength ranges.

This can be done by using a half mirror as the optical element 9 and by arranging a color separation filter (color filter) on the same side as at least one of the first and second surfaces so that the filter faces an associated one of the photosensitive cells. In this case, the half mirror is designed to transmit approximately a half of the incoming light and reflect the rest of it, while the color filter is designed to transmit only a light ray falling within a wavelength range associated with a particular color component. If color filters that transmit light rays with mutually different color components are arranged on both of the two sides of the semiconductor layer (which are represented by its first and second surfaces) so as to face one photosensitive cell, then that photosensitive cell will receive light rays falling within mutually different wavelength ranges that have come through the two surfaces. Optionally, if the color separation filters that are arranged to face two photosensitive cells included in the same unit block are associated with mutually different color components, then those two photosensitive cells will be able to receive light rays falling within mutually different wavelength ranges, too.

As used herein, if “two light rays fall within mutually different wavelength ranges”, then it means that the major color components included in the two light rays are different from each other. For example, if one light ray is a magenta (Mg) ray and the other is a red (R) ray, the major color components of the magenta ray are red (R) and blue (B), which are different from the major color component red (R) of the red ray. Consequently, the magenta ray and the red ray should fall within mutually different wavelength ranges.

With such an arrangement adopted, the photoelectrically converted signals supplied from the respective photosensitive cells in each unit block include a color mixture signal, and the color information of the light entering each block can be obtained by making signal computations between the respective photosensitive cells.

Hereinafter, specific preferred embodiments of the present invention will be described with reference to the accompanying drawings. In the drawings and in the following description, any pair of components shown in multiple drawings or mentioned for multiple different embodiments and having substantially the same function will be identified by the same reference numeral.

### EMBODIMENT 1

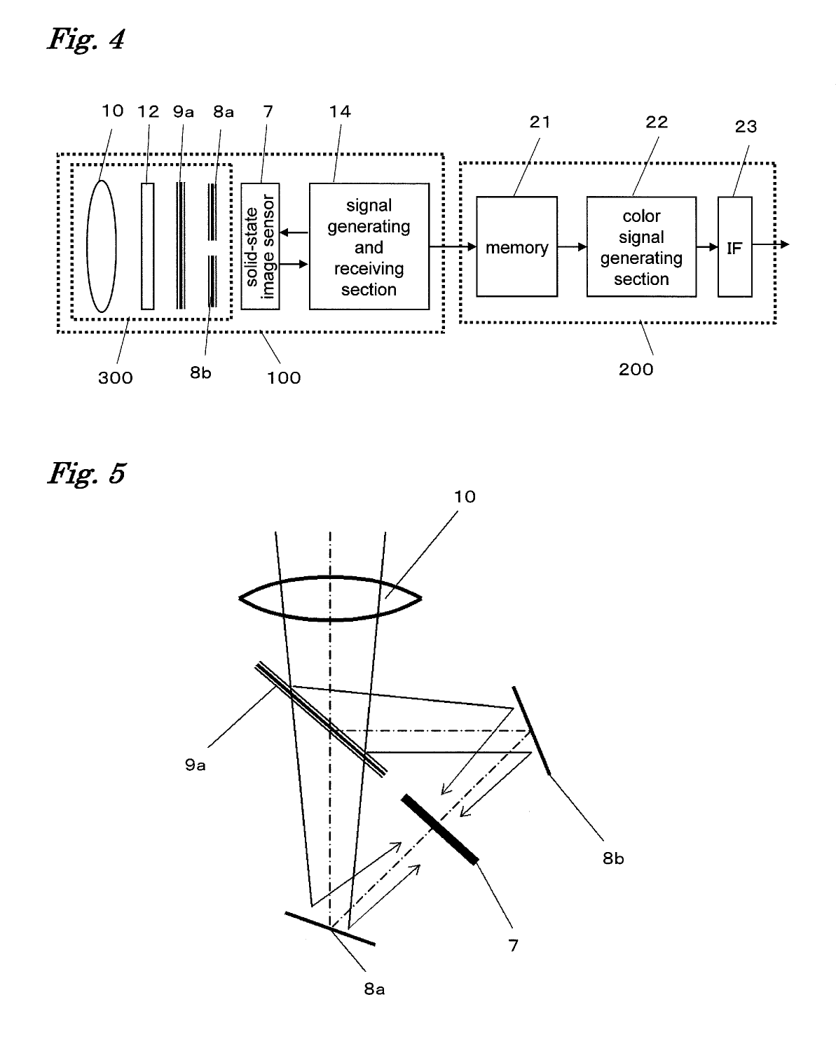

FIG. 4 is a block diagram illustrating an overall configuration for an image capture device as a first specific preferred embodiment of the present invention. The image capture device shown in FIG. 4 includes an image capturing section 100 and a signal processing section 200 that receives a signal from the image capturing section 100 and outputs a signal including color information. Hereinafter, the image capturing section 100 and the signal processing section 200 will be described.

The image capturing section 100 includes an optical system 300 for imaging a given subject, a solid-state image sensor 7 for converting optical information, which has been collected by imaging the subject through the optical system 300, into an electrical signal by photoelectric conversion, and a signal generating and receiving section 14. The optical system 300 includes a lens 10, an optical plate 12, a half mirror 9a, and reflective mirrors 8a and 8b. In this case, the optical plate 12 is a combination of a quartz crystal low-pass filter for reducing a moiré pattern to be caused by a pixel arrangement with an infrared cut filter for filtering out infrared rays. The half mirror 9a is designed to split the incoming light into two light rays going in two different directions by transmitting roughly a half of the light that has passed through the lens 10 and by reflecting the rest of the light. Those two split light rays going in two different directions are reflected by the reflective mirrors 8a and 8b and then strike respectively the principal and back surfaces of the solid-state image sensor 7. The signal generating and receiving section 14 generates a fundamental signal to drive the solid-state image sensor 7 and receives a signal from the solid-state image sensor 7 and passes it to the signal processing section 200.

The signal processing section 200 includes a memory 21 to store the signal supplied from the signal generating and receiving section 14, a color signal generating section 22 for generating a signal including color information (i.e., a color signal) using the data that has been read out from the memory 21, and an interface (IF) section 23 that outputs the color signal to an external device.

It should be noted that this configuration is only an example and that according to the present invention, all components but the solid-state image sensor 7 and the optical system 300 can be an appropriate combination of known elements. Hereinafter, the solid-state image sensor 7 and the optical system 300 of this preferred embodiment will be described.

FIG. 5 schematically illustrates the arrangement of the solid-state image sensor 7 and the optical system 300 according to this preferred embodiment. The solid-state image sensor 7 is a dual-side illumination image sensor, includes a transparent substrate that supports a semiconductor layer, and can receive incoming light both at its principal surface with an interconnect layer and at its back surface with no interconnect layer. On both of these two sides, color filters are arranged on a one-color-per-pixel basis. In such an arrangement, the incoming light that has come from the subject passes through the lens 10, is split by the half mirror 9a into two light rays, which are reflected from the reflective mirrors 8a and 8b and then enter the image sensor 7 on both sides thereof. It should be noted that according to the present invention, the solid-state image sensor 7 and the optical system 300 do not always have to be arranged as shown in FIG. 5. For example, the number of reflective mirrors provided does not have to be two but may also be three or more. Optionally, either the light ray that has been transmitted through the half mirror 9a or the light ray that has been reflected from the half mirror 9a may directly enter the solid-state image sensor 7 without being reflected from the reflective mirror. In any case, however, the optical system 300 should be designed and arranged so that the images produced by the two light rays, which have entered the solid-state image sensor 7 through both of its two surfaces, on the photosensitive plane of the solid-state image sensor 7 have their focal points and locations exactly matched to each other with respect to the two light rays.

The solid-state image sensor 7 of this preferred embodiment includes a semiconductor layer with top and bottom surfaces, between which a lot of photosensitive cells are arranged two-dimensionally to form a photosensitive cell array. Each of the light rays that have been reflected from the two reflective mirrors 8a and 8b enters the photosensitive cell array through either the top surface or the bottom surface. Each photosensitive cell is typically a photodiode, which performs photoelectric conversion and outputs an electrical signal representing the intensity of the light received (which will be referred to herein as a “photoelectrically converted signal”). The solid-state image sensor 7 is typically implemented as a CMOS sensor and is fabricated by known semiconductor device processing technologies. The solid-state image sensor 7 is electrically connected to a processing section including drivers and signal processors (not shown).

On the same side as the principal surface of the solid-state image sensor 7, a first filter array consisting of multiple color filters is arranged to face the photosensitive cell array so that each color filter faces an associated one of the pixels. In the same way, on the same side as the back surface, a second filter array consisting of multiple color filters is arranged on a one-color-filter-per-pixel basis, too. Each of those color filters is designed to transmit only a light ray falling within a wavelength range associated with a particular color component. In the following description, when a color component is identified by C, a color filter that transmits the color component C will be referred to herein as “C element”.

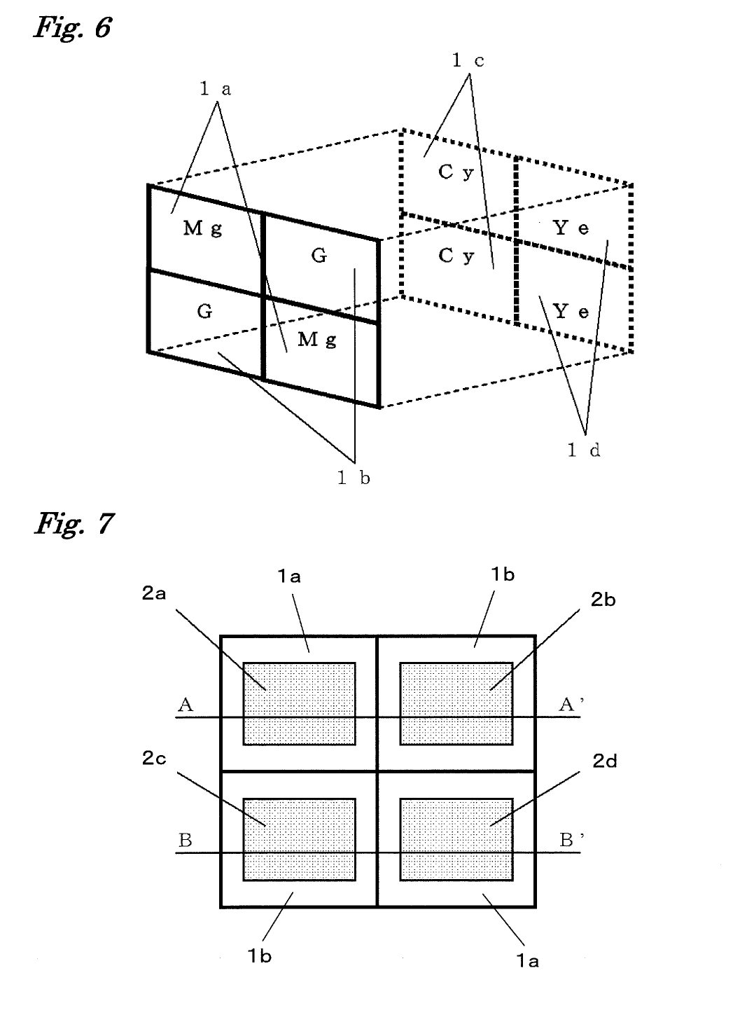

FIG. 6 illustrates a basic arrangement for color filters according to this preferred embodiment. In the example illustrated in FIG. 6, the color filters are arranged with the scanning method supposed to be progressive scanning. In FIG. 6, the color filters indicated by the solid lines are arranged on the same side as the principal surface of the image sensor, while the color filters indicated by the dotted lines are arranged on the same side as the back surface of the image sensor. On both of the principal and back surface sides, the color filters are basically arranged in two columns and two rows. Specifically, on the principal surface side, magenta (Mg) elements 1a and green (G) elements 1b are arranged in a matrix of color elements. On the back surface side, on the other hand, cyan (Cy) elements 1c and yellow (Ye) elements 1d are arranged in vertical stripes.

Hereinafter, the basic arrangement of the image sensor of this preferred embodiment will be described with reference to FIGS. 7 to 9. FIG. 7 is a plan view of the image sensor as viewed from over its principal surface. Photosensitive cells 2a, 2d, 2b and 2d are arranged so as to face the two magenta elements 1a and the two green elements 1b, respectively. Meanwhile, on the back surface side, a cyan element 1c, a yellow element 1d, another cyan element 1c and another yellow element 1d are arranged to face the photosensitive cells 2a, 2b, 2c and 2d, respectively.

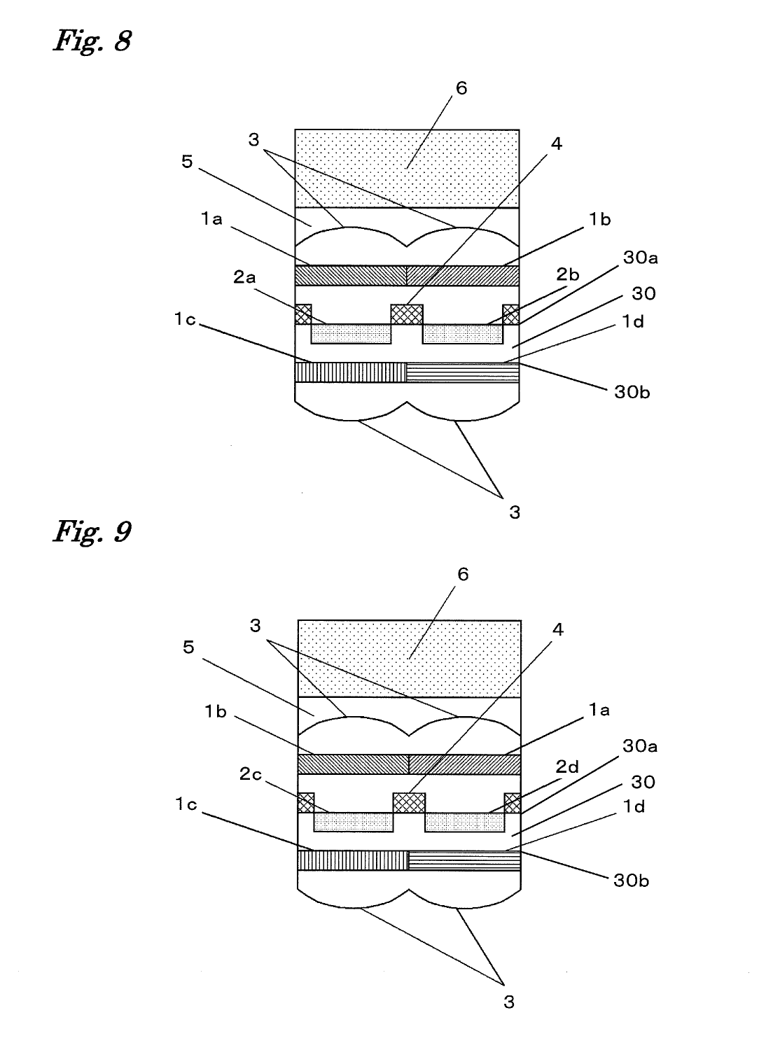

FIG. 8 is a cross-sectional view as viewed on the plane A-A′ shown in FIG. 7. As shown in FIG. 8, the interconnect layer 4 is arranged on the same side as the first surface (i.e., the principal surface) 30a of the semiconductor layer 30. The magenta and green elements 1a and 1b are arranged on the principal surface side and the cyan and yellow elements 1c and 1d are arranged on the back surface side to face the photosensitive cells 2a and 2b, respectively. Also, micro lenses 3 for condensing light effectively on the photosensitive cells are further arranged to face the respective color filters 1a through 1d. Furthermore, on the principal surface side, the transparent substrate 6 is arranged to support the semiconductor layer 30, the interconnect layer 4 and so on. The transparent substrate 6 is bonded to the semiconductor layer 30 with a transparent member 5, which has a lower refractive index than the micro lenses 3.

FIG. 9 is a cross-sectional view as viewed on the plane B-B′ shown in FIG. 7. On this B-B′ plane, the magenta and green elements 1a and 1b change their positions with each other, compared to the A-A′ plane. In the arrangements shown in FIGS. 7 to 9, the transparent substrate 6 arranged on the principal surface side is transparent, and therefore, the image sensor can receive the incoming light not only through the back surface but also through the principal surface as well.

The structures shown in FIGS. 8 and 9 can be fabricated by known semiconductor device processing. To form such a structure, the following process may be carried out, for example. First of all, an array of photosensitive cells is formed in a surface region of a semiconductor substrate with a certain thickness, and then an interconnect layer 4, a first filter array, micro lenses 3 and other members are arranged thereon. Subsequently, the semiconductor substrate and a transparent substrate are bonded together with a transparent member 5. Thereafter, the back surface side of the semiconductor substrate is polished or etched to have its thickness reduced to several micrometers, for example, thereby forming a semiconductor layer 30. After that, a second filter array, micro lenses 3 and other members are arranged on the back surface side. In this process step, the members on the back surface side are aligned with their counterparts on the principal surface side so that when incoming light strikes both sides of this structure, two images produced on the array of photosensitive cells will exactly match to each other.

The image capture device of this preferred embodiment receives the incoming light at both surfaces of its image sensor. Thus, the photosensitive cells 2a through 2d respectively output signals S2a, S2b, S2c and S2d represented by the following Equations (8) through (11):

S2a=Ms+Cs (8)

S2b=Gs+Ys (9)

S2c=Gs+Cs (10)

S2d=Ms+Ys (11)

where Ms, Gs, Cs and Ys denote the photoelectrically converted signals of magenta, green, cyan and yellow rays as described above.

Using the red, green and blue components Rs, Gs and Bs, these Equations (8) through (11) can be modified into the following Equations (12) through (15), respectively:

S2a=Rs+Gs+2Bs (12)

S2b=Rs+2Gs (13)

S2c=2Gs+Bs (14)

S2d=2Rs+Gs+Bs (15)

Furthermore, by adding signals representing two horizontal pixels, the following Equation (16) can be obtained:

S2a+S2b=S2c+S2d=2Rs+3Gs+2Bs(=YL) (16)

And by subtracting signals representing two horizontal pixels, the following Equations (17) and (18) can be obtained:

S2a−S2b=2Bs−Gs(=BY) (17)

S2d−S2c=2Rs−Gs (=RY) (18)

Equation (16) is an alternative representation of the luminance signal YL given by Equation (5). On the other hand, Equations (17) and (18) are alternative representations of the color difference signals BY (=2Bs−Gs) and RY (=2RS−Gs) given by Equations (6) and (7), respectively.

After all, by calculating signals on only one line, the luminance signal Y and the color difference signals BY and RY can all be obtained. As a result, good performance is realized in terms of vertical resolution and false colors. Furthermore, since the component colors disclosed in Patent Documents Nos. 2 and 3 are used, high sensitivity and good color separation can be achieved as well.

As described above, the image capture device of this preferred embodiment arranges magenta and green elements in matrix on the same side as the principal surface of an image sensor on a one-color-per-pixel basis, and also arranges cyan and yellow elements in stripes on its back surface side on a one-color-per-pixel basis, too. By capturing images on both of the principal and back surface sides of the image sensor, the color representation performance achieved will be as good as if two color filters were used per pixel.

The color filters arranged on the principal surface side in the preferred embodiment described above may be exchanged for the ones arranged on the back surface side. That is to say, even if magenta and green elements are arranged on the back surface side and if cyan and yellow elements are arranged on the principal surface side, the effect of the present invention will also be achieved.

In the preferred embodiment described above, the progressive scanning method is supposed to be adopted. However, the present invention is in no way limited to that specific preferred embodiment. Rather, as long as basic colors are arranged so as to be compatible with interlaced scanning or any other scanning method, good color representation performance will also be achieved by making the image sensor receive the incoming light at both of its surfaces.

Also, depending on the structure of the solid-state image sensor, the incoming light rays that have entered the image sensor through its surface with the interconnect layer and through its back surface with no interconnect layers might be lost in mutually different percentages before reaching the photosensitive cells. In that case, the optical transmittance of the half mirror may be adjusted with their difference in optical loss percentage taken into account. In this respect, the half mirror does not have to be designed so as to split the incoming light evenly into two light rays with quite the same intensity. Rather, the transmittance of the light may be adjusted appropriately.

### EMBODIMENT 2

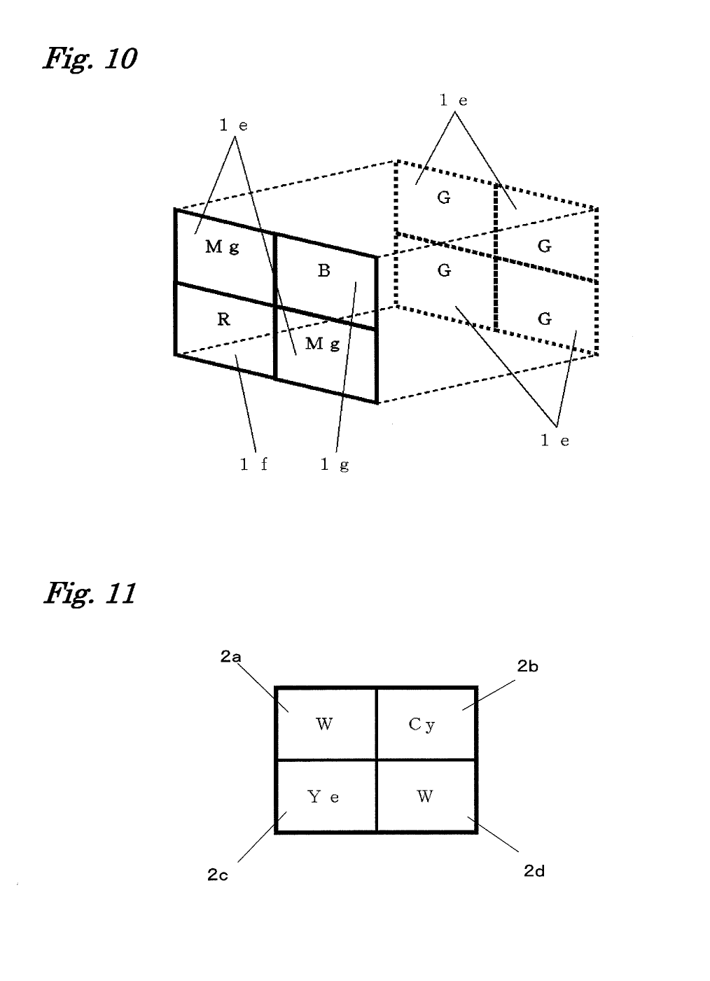

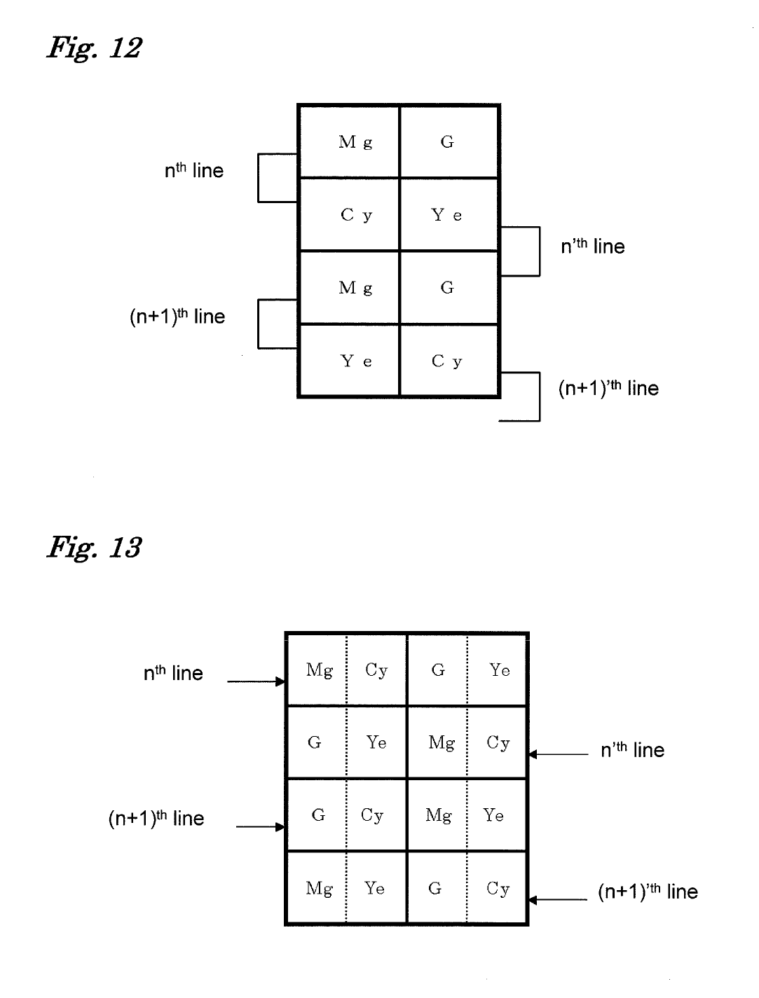

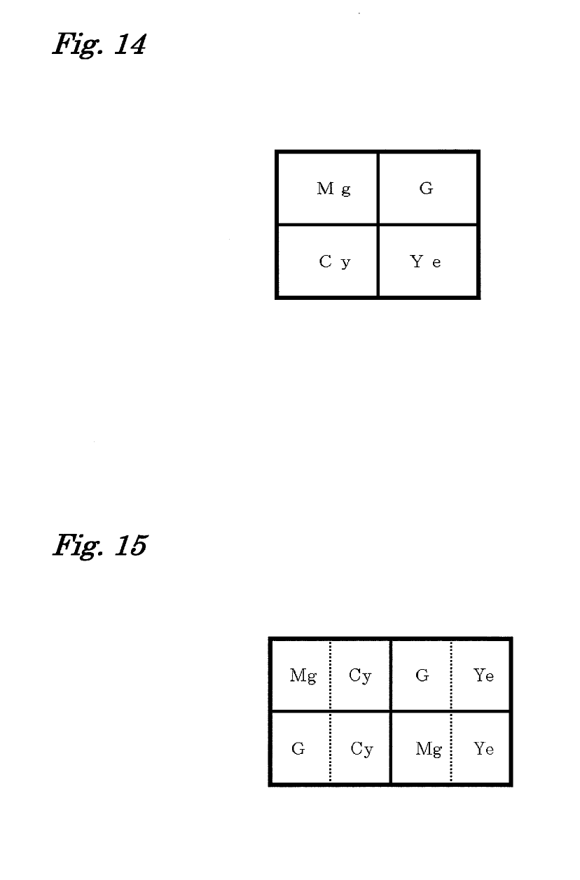

Hereinafter, a second preferred embodiment of the present invention will be described. The image capture device of the second preferred embodiment of the present invention is the same as the counterpart of the first preferred embodiment described above except that the half mirror functioning as the optical element 9 is replaced with a multilayer interference filter (i.e., a dichroic mirror) and that the basic color arrangements of color filters are changed into the one shown in FIG. 10. Thus, the following description of the second preferred embodiment will be focused on only those differences from the first preferred embodiment to avoid redundancies.

The dichroic mirror of this preferred embodiment is designed to transmit a magenta ray and reflect a green ray. As a result, the magenta ray will strike the principal surface side of the image sensor and the green ray will strike the back surface side of the image sensor. In this preferred embodiment, an array of color filters is arranged on the principal surface side so as to face the array of photosensitive cells, while transparent elements are arranged on the back surface side.

FIG. 10 illustrates the basic color arrangement of color filters according to this preferred embodiment. In FIG. 10, the solid lines indicate the color arrangement on the principal surface side of the image sensor, while the dotted lines indicate the color arrangement on the back surface side of the image sensor. On the principal surface side of the image sensor, transparent elements 1e are arranged diagonally and red and blue elements 1f and 1g are also arranged diagonally. As a result, the photosensitive cells at the intersection between the first row and the first column and at the intersection between the second row and the second column will receive as they are magenta rays that have been transmitted through the transparent elements 1e. The photosensitive cell at the intersection between the first row and the second column will receive a blue ray. And the photosensitive cell at the intersection between the second row and the first column will receive a red ray. On the back surface side of the image sensor, on the other hand, transparent elements are arranged over the entire surface, and therefore, the respective photosensitive cells will receive a green ray as it is. After all, as incoming light is received at both of the principal and back surfaces of the image sensor, the photosensitive cells at the intersection between the first row and the first column and at the intersection between the second row and the second column will receive all of the incoming visible radiation components (W), the photosensitive cell at the intersection between the first row and the second column will receive a cyan ray, and the photosensitive cell at the intersection between the second row and the first column will receive a yellow ray when viewed from over the principal surface of the image sensor.

The color arrangement of the light rays received eventually by the photosensitive cells 2a, 2b, 2c and 2d is shown in FIG. 11. This color arrangement corresponds to that of the pixel signals output by the photosensitive cells 2a, 2b, 2c and 2d. The respective pixel signals are represented by the following Equations (19) to (22):

S2a=Rs+Gs+Bs (19)

S2b=Gs+Bs (20)

S2c=Rs+Gs (21)

S2d=Rs+Gs+Bs (22)

These signals reveal that the image capturing method of this preferred embodiment will result in very little optical loss. In actual color representation, Rs and Bs signals are extracted by calculating the difference between the signals representing two horizontal pixels as by the following Equations (23) and (24):

S2a−S2b=Rs (23)

S2d−S2c=Bs (24)

By making calculations on these two signals and on the luminance signal YL, which is obtained by adding together the signals representing the four pixels as in the following Equation (25),

YL=S2a+S2b+S2c+S2d=3Rs+4Gs+3Bs (25)

a Gs signal is generated as represented by the following Equation (26):

Gs=(YL−3Rs−3Bs)/4 (26)

By performing these processing steps, a color image signal can be generated. It should be noted that even if the arrangement described above is not used (i.e., even if an image sensor that receives incoming light only at one of the two surfaces thereof is used), the same degree of performance will be achieved by performing similar processing steps as long as W, Cy, W and Ye color elements are arranged on one side of the image sensor. Recently, however, the smaller the feature size of an image sensor gets year after year, the more and more difficult it has become for the color elements (i.e., color filters) to realize light-splitting characteristics as intended. That is why according to this preferred embodiment, the incoming light is split by a dichroic mirror into a magenta ray and a green ray, which are then respectively directed toward the principal surface and the back surface of the image sensor. With such an arrangement, it is not always necessary to design the blue or red element 1f or 1g of this preferred embodiment so that the element 1f or 1g transmits exactly only a blue ray or a red ray. Instead, if the blue and red elements 1f and 1g are replaced with a color element that transmits a blue to cyan based light ray and a color element that transmits a red to yellow based light ray, respectively, the photosensitive cells can still receive the blue and red rays properly. And if these light rays are combined with the green ray that has come through the back surface, a cyan ray and a yellow ray can be received just as intended. That is to say, to realize the light-splitting property of a cyan element or a yellow element, the blue element 1g and the red element 1f may have their light-splitting range cover a blue to cyan range or a red to yellow range. Consequently, the image capture device of this preferred embodiment can extend the tolerance of color filters being made.

As described above, according to this preferred embodiment, a dichroic mirror that splits the incoming light into a magenta ray and a green ray, color filters consisting of blue and red elements, and an image sensor that can receive the incoming light at both of the principal and back surfaces thereof are used. The image capture device of this preferred embodiment would achieve as good performance as an image capture device including a color image sensor that can receive light at only one of the two sides thereof, on which W, Cy, W and Ye color filters are arranged. On top of that, the image capture device of this preferred embodiment can extend significantly the tolerance of the light-splitting property of color filters being made, which is very beneficial to get its manufacturing process done smoothly.

The color filters and the transparent elements arranged on the principal surface side in the preferred embodiment described above may be exchanged for the transparent elements arranged on the back surface side. That is to say, the transparent elements and the red and blue elements could be arranged on the back surface side and the transparent elements could be arranged on the principal surface side instead. In that case, the optical system including the dichroic mirror should be designed to make the magenta ray strike the back surface side of the image sensor and to make the green ray strike the principal surface side of the image sensor.

Furthermore, in the preferred embodiments described above, the final basic color arrangement is supposed to be W, Cy, W and Ye. However, this is only an example. Alternatively, any other color arrangement may also be used as long as the light-splitting property of an image sensor can be controlled using the principal and back surfaces thereof. When a different color arrangement is adopted, a dichroic mirror for splitting the incoming light into primary color rays and complementary color rays according to that color arrangement needs to be used. Also, if the quantity of the light received at the top of a photosensitive cell is different from that of the light received at its bottom due to the structural problem with the image sensor, the quantities of the light received at the top and the bottom could also be adjusted by varying the transmittance of the transparent element 1e arranged on the back surface. Such a modification would not depart from the spirit of the present invention, either.

### INDUSTRIAL APPLICABILITY

The image capture device of the present invention can be used extensively in cameras that use a solid-state image sensor for general consumers including so-called “digital cameras” and “digital movie cameras”, solid-state camcorders for TV broadcast personnel, industrial solid-state surveillance cameras, and so on. It should be noted that the present invention is applicable to every kind of color cameras even if the imaging device is not a solid-state image sensor.

### REFERENCE SIGNS LIST

1a magenta element of color filter
1b green element of color filter
1c cyan element of color filter
1d yellow element of color filter
1e transparent element
1f red element of color filter
1g blue element of color filter
2, 2a, 2b, 2c, 2d photosensitive cell of image sensor
3 micro lens
4 interconnect layer
5 transparent material
6 transparent substrate
7 dual-side illumination image sensor
8a, 8b reflective mirror
9 optical element
9a half mirror
10, 11, 13 lens
12 optical plate
14 signal generating and receiving section
20 unit block of photosensitive cell array
21 memory
22 color signal generating section
23 interface section
30 semiconductor layer
30a first surface of semiconductor layer
30b second surface of semiconductor layer
100 image capturing section
200 signal processing section
300 optical system

1. An image capture device comprising:
a solid-state image sensor; and
an optical system, which is arranged to make incoming light enter the solid-state image sensor,
wherein the solid-state image sensor includes:
a semiconductor layer, which has a first surface and a second surface that is opposed to the first surface; and
a number of photosensitive cells, which are arranged two-dimensionally in between the first and second surfaces of the semiconductor layer thereof, and
wherein the optical system includes an optical element for splitting the incoming light into first and second light rays, and makes the first and second light rays respectively strike the first and second surfaces of the semiconductor layer, and
wherein the photosensitive cells are grouped into multiple unit blocks, each including a plurality of photosensitive cells, and
wherein at least one of the photosensitive cells included in each said unit block receives not only a part of the first light ray but also a part of the second light ray that falls within a different wavelength range from that part of the first light ray simultaneously, and
wherein in each said unit block, at least two photosensitive cells receive light rays falling within mutually different wavelength ranges.

2. (canceled)

3. The image capture device of claim 1, wherein the optical element is a half mirror that transmits a half of the incoming light as the first light ray and that reflects the other half of the incoming light as the second light ray, and
wherein the solid-state image sensor includes
a first filter array that is made up of a number of color separation filters, each of which is arranged on same side as the first surface to face an associated one of the photosensitive cells, and
a second filter array that is made up of a number of color separation filters, each of which is arranged on the same side as the second surface to face an associated one of the photosensitive cells.

4. The image capture device of claim 3, wherein each said unit block includes first, second, third and fourth photosensitive cells, and
wherein the first and second filter arrays are arranged to make magenta and cyan rays of the incoming light incident on the first photosensitive cell, green and yellow rays of the incoming light incident on the second photosensitive cell, green and cyan rays of the incoming light incident on the third photosensitive cell, and magenta and yellow rays of the incoming light incident on the fourth photosensitive cell, respectively.

5. The image capture device of claim 1, wherein the optical element is a dichroic mirror for splitting the incoming light into a first light ray that represents a primary color and a second light ray that represents its complementary color, and
wherein the solid-state image sensor includes a filter array that is made up of multiple color separation filters, each of which is arranged on the same side as the first surface so as to face an associated one of the photosensitive cells.

6. The image capture device of claim 5, wherein the dichroic mirror is arranged so as to split the incoming light into magenta and green rays, and
wherein each said unit block includes first, second, third and fourth photosensitive cells, and
wherein the filter array is arranged to make magenta and green rays of the incoming light incident on the first and second photosensitive cells, red and green rays of the incoming light incident on the third photosensitive cell, and blue and green rays of the incoming light incident on the fourth photosensitive cell, respectively.

7. The image capture device of claim 1, further comprising a signal processing section, which processes a photoelectrically converted signal supplied from each of the photosensitive cells included in each said unit block and outputs a signal that carries color information about the light that has entered each said unit block.

8. A dual-side illumination solid-state image sensor comprising:
a semiconductor layer, which has a first surface and a second surface that is opposed to the first surface; and
a number of photosensitive cells, which are arranged two-dimensionally in between the first and second surfaces of the semiconductor layer thereof,
wherein the photosensitive cells are grouped into multiple unit blocks, each including a plurality of photosensitive cells, and
wherein at least one of the photosensitive cells included in each said unit block receives not only a first light ray that has come through the first surface but also a second light ray that has come through the second surface and that falls within a different wavelength range from that part of the first light ray simultaneously, and
wherein in each said unit block, at least two photosensitive cells receive light rays falling within mutually different wavelength ranges.
